(19) United States
(12) Patent Application Publication
(10) Pub. No.: US 2021/0287121 A1
(43) Pub. Date: Sep. 16, 2021

(54) Real-time Configurator Validation and Recommendation Engine

(71) Applicant: Bray International, Inc., Houston, TX (US)

(72) Inventors: Ron Veillon, Katy, TX (US); Alan Reese, Tomball, TX (US); Miguel Lezcano, Tomball, TX (US); Travis Ledford, Katy, TX (US)

(21) Appl. No.: 17/202,687

(22) Filed: Mar. 16, 2021

Related U.S. Application Data
(60) Provisional application No. 62/990,007, filed on Mar. 16, 2020.

(51) Int. Cl. G06N 5/04; G06N 5/02; G06N 20/00

(52) U.S. Cl. CPC G06N 5/04; G06N 20/00; G06N 5/025

(57) ABSTRACT

The disclosure relates to a method of real-time configurator validation and recommendation (or an engine for real-time configurator validation and recommendation) having the steps of: collecting historical quotation or sales data; identifying a plurality of solutions based on the data; ranking the plurality of solutions by frequency; returning the plurality of solutions in a ranked order; calculating a subset of probabilities; generating a rule or ruleset; ranking the rules or ruleset; storing the generated and ranked rules or ruleset as a generated learned rule or ruleset; inserting or substituting explicit rules or new configurations; adding a first assembly item; querying the generated learned rules or rulesets; receiving the plurality of solutions in ranked order; and displaying the plurality of solutions or recommendations on a user interface.

### BACKGROUND

Technical field: The present disclosure pertains to manufacturer product configuration technologies and software for assembling product kits.

Conventional approaches to product configuration currently exist primarily in one of two following modes: unguided product configurators and guided product configurators.

Unguided configurators/configuration require little software sophistication to implement, but rely on a sales team with very high product knowledge to avoid configuration mistakes that could lead to long lead times and higher manufacturing costs. For unguided configurators, the burden of product knowledge and learning falls entirely on the sales force. As the product catalog grows, the amount of information required to configure accurately grows exponentially and quickly exceeds the capacity of even the most experienced salesperson.

Guided configurators/configuration or “constraint based” configurators solve some of the problems of the unguided approach, but require configuration rules to be explicitly defined prior to implementation. For complex configuration rulesets, this creates a barrier to implement and requires heavy maintenance and overhead going forward. For organizations with hundreds or thousands of products and product parts, product SKUs, or other product identifiers, explicit inclusion or explicit rulesets of every conclusion is extremely and prohibitively time consuming.

Therefore a need exists to augment the explicit ruleset of the guided configuration approach with a machine-learned ruleset based on previously quoted or available configurations. There exists a further need for a path for product experts to promote learned rules into explicit rules into the improved configurator, and for configurators to optimize providing rulesets and configurations in a short amount of time.

### BRIEF SUMMARY OF THE EMBODIMENTS

The disclosure relates to a method of real-time configurator validation and recommendation (or an engine for real-time configurator validation and recommendation) having the steps of: collecting historical quotation or sales data; identifying a plurality of solutions based on the data; ranking the plurality of solutions by frequency; returning the plurality of solutions in a ranked order; calculating a subset of probabilities; generating a rule or ruleset; ranking the rules or ruleset; storing the generated and ranked rules or ruleset as a generated learned rule or ruleset; inserting or substituting explicit rules or new configurations; adding a first assembly item; querying the generated learned rules or rulesets; receiving the plurality of solutions in ranked order; and displaying the plurality of solutions or recommendations on a user interface.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a flow-chart diagram of an exemplary embodiment of the process responsible for generating a configuration ruleset.

FIG. 2 depicts a flow-chart diagram of an exemplary embodiment of the artificial intelligence assisted (herein after, also referred to as “AI-assisted”) configuration process.

FIG. 3 depicts a schematic diagram of an exemplary embodiment of a microcontroller or microprocessor for the configuration processes as described for FIG. 1 or 2.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

Within the manufacturing industry, enterprises that make an array of products consisting of multiple components often have difficulty providing their sales teams with the information and tools to know all the ways that these components can and cannot be configured or combined and offered to end-users. The different combinations of items in product kits or assemblies can easily number in the thousands or tens of thousands, which is prohibitively difficult for any sales team to effectively consider all such combinations in a conventional unguided configurator, and also difficult to program all such combinations via explicit rules in a conventional guided configurator, which may also quickly become outdated. As described in detail below, an improved configuration technique is presented to efficiently compute likely configurations or correlations between products and present results to end-users.

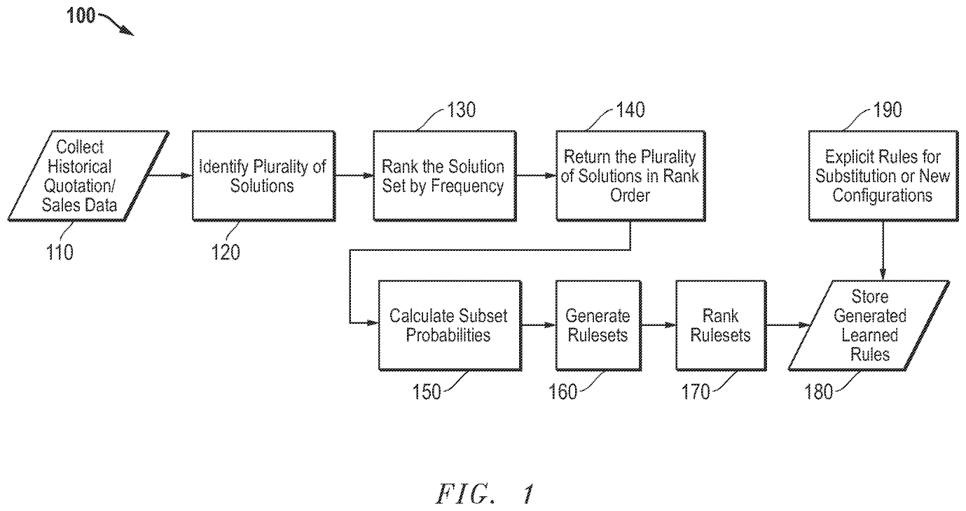

Referring to FIG. 1, the implementation of the configuration engine 100 begins with the generation of a learned configuration ruleset based on historical data in block 110. In the step/block 110 of collecting historical data, sales, past transactions and/or quotation history or market-based data is extracted from source systems at a transaction level with details and variables regarding the components included in each transaction. In step/block 120 a plurality of solutions is identified via transforming data into one-hot encoded dataframe and applying frequent pattern-growth algorithm with a derived candidacy threshold to generate a reduced list of frequent itemsets. The output of this step 120 is a list of key-value pairs where the key is the list of items in a given configuration and the value is the frequency (also termed ‘support’) with which that itemset (wherein an itemset is a combination of more than one item) appears in the sales history—this is referred to as a list of frequent itemsets. In step/block 130, the solution set is ranked by frequency, wherein the list of FP itemsets or frequent pattern itemsets is ranked by the support metric. In step/block 140, the plurality of solutions or solution set is returned in rank order. In step/block 150, the subset of probabilities is calculated, wherein the itemsets are broken into antecedent-consequent pairs and the following two metrics are calculated: confidence and lift. The confidence metric is defined as the support of the antecedent (the first item) and consequent (or associated item) together relative to the support of the antecedent overall. The confidence metric represents the likelihood that the consequent (associated item) will result or occur given the antecedent (first item). The lift metric is defined as the confidence of an antecedent-consequent pair relative to the overall support of the consequent. If the consequent only ever appears in transactions when the antecedent is present, the “lift” metric of the pair will be high. If the consequent is ubiquitous, the lift metric will be low. In step/block 160, rulesets are generated wherein association rules and output metrics quantifying the strength of the association are created or formalized. In step/block 170, the rulesets are ranked or weighted, wherein the rules and/or rulesets are first ranked by the ‘lift’ metric, then by the ‘confidence’ metric, to provide or give priority to consequents that are highly associated with their antecedents. The generated and ranked rules and rulesets of step/block 170 may be considered the ‘learned’ rules or rulesets. In step/block 180 the generated learned rules or rulesets are stored and/or sorted, wherein the rules/rulesets are stored in an optimal structure for rapid retrieval by a quoting system. In step/block 190, a user of the configuration engine 100 may include or insert explicit rules (such as, constraint based or guided rules), substitute existing rules, or add new configurations into the learned rules set of configuration engine 100. New rules/configurations may be included where a product is new or has never been sold, wherein explicit rules may be needed and/or there are no historical association data.

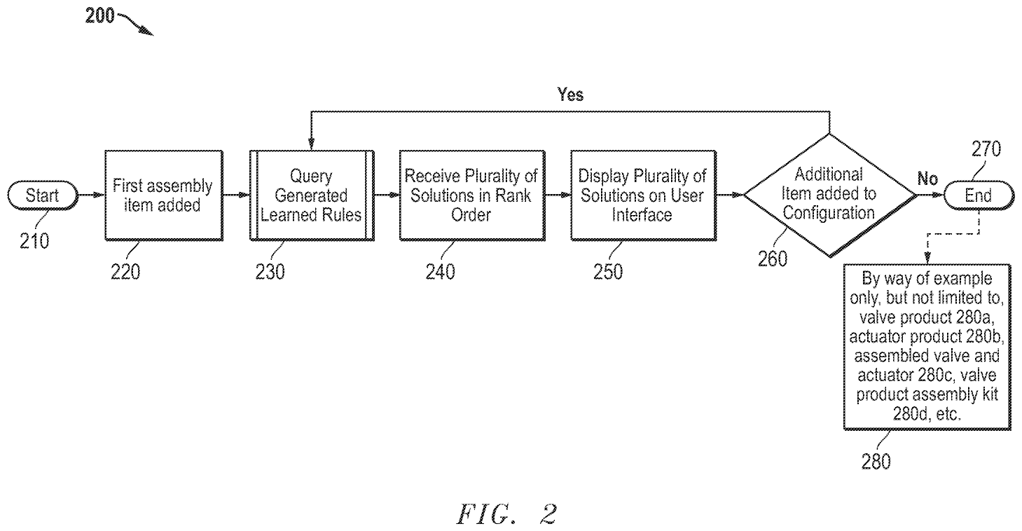

FIG. 2 depicts a flow-chart diagram of an exemplary embodiment of the artificial intelligence assisted (or also, “AI-assisted”) configuration process 200, which starts at the step/block 210. In the subsequent step/block 220 a first assembly item may be added. In the next step/block 230, the generated learned rules from the configuration process 100 may be queried with the first assembly item. Subsequently, in the following step or block 240, a plurality of solutions in ranked order may be received as provided from the generated and learned rules of process 100. In the following step/block 250, these plurality of solutions may be displayed on a user interface as user recommendations. In the next step/block 260, additional items may be added or inserted to the configuration process 200. If an additional item is added/inserted, the AI-assisted configuration process 200 queries the generated learned rules at step/block 230 and repeats the steps or blocks 230 to 260 until no further additional items are desired to be added to the configuration 200. If no additional items are added under step/block 230, then the configuration process 200 ends at step/block 270. The end 270 may further include a configured product, assembled item or product kit 280 (by way of example only, but not limited to, valve product 280a, actuator product 280b, assembled valve and actuator 280c, valve product assembly kit 280d, etc.). The teachings of US patent publication no. US 2020/0116170 A1 are herein incorporated by reference as examples of configured product 280 such as valve product 280a, actuator product 280b, assembled valve and actuator 280c, etc.

By way of example, an end user may begin at steps 210 and/or 220 by starting a quote and adding a first assembly or configured item, such as a particular valve or control device. The configuration process 200 then in step 230 queries the valve item (as added into step 220) against the generated learned rules of the process 100 of FIG. 1. The configuration process 200 may receive a plurality of solutions in ranked order in step 240, which is then displayed to an end-user on a user interface on step 250. These ranked solutions or recommendations may include valve or control devices accessories sold in connection with the valve in the past, as ranked by frequency of how often the two items are sold together based on historical data, as provided by configuration process 100 in FIG. 1. The end-user (in certain exemplary embodiments, this may be a sales agent) may optionally select from the ranked solutions displayed on the user interface, such as a recommended or suggested valve actuator, or other suitable or compatible accessory for a valve or control device, such as an appropriate and compatible mounting kit, including part numbers, to add to the configuration or kit assembly in step 260. The ranked solutions may take into account dimensions of an antecedent item, compatibility, amongst other variables and suggest accessories including, by way of example, and not limited to: couplings, valve monitors, valve sensors, positioners, actuators, communication devices, regulators, and so forth. If an additional item is added in step 260, the process or transaction 200 may go back to step 230 and proceed down the subsequent steps 230 to 260 as needed until no additional items are desired to be added to the product assembly kit. The configuration process 200 may then end at step 270. The data from the configuration process 200 may then be collected as per step 110 of the configuration process 100 for enhancing the efficacy of the generated learned ruleset.

The subject disclosure dramatically improves upon existing models for product configuration by applying computational algorithms to the purpose of recommending components for a given quotation process. As specified, the process depicted by FIGS. 1 and 2 provides for flexibility in implementation by using a combined learned and explicit ruleset to guide product configuration.

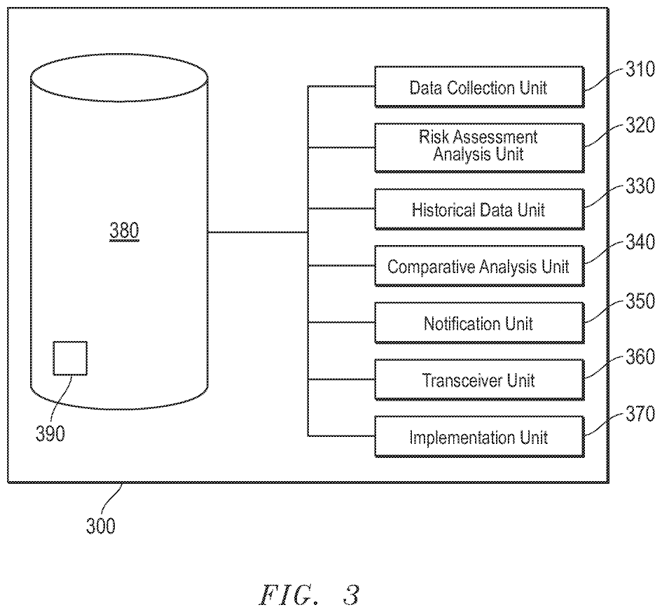

FIG. 3 depicts a schematic diagram of an exemplary embodiment of a microcontroller or microprocessor 300 for the configuration processes 100 and/or 200. The microprocessor, microcontroller or computing unit 300 may have components including, but not limited to, a storage device 380, a data collection unit 310, a risk assessment or analysis unit 320, a historical data unit 330, a comparative analysis unit 340, a notification or alarm unit 350, a transceiver unit 360, and optionally an implementation unit 370. Generally, any description or disclosure regarding analysis and processing (including processes 100 and 200) based on retrieved/observed, historical data, measurements or metrics 390 that is described as performed by the microprocessor 300 may be performed by remotely/wirelessly, in the cloud, or as connected to components via wire or cable connections. The configuration processes 100, 200 may be performed generally via the computing unit 300, and specific steps of processes 100,200 may optionally be performed on one or more of the components of computing unit 300 as further described below (such as the data collection unit 310, storage device 380, historical data unit 330, risk analysis unit 320 and comparative analysis unit 340, by way of example only).

The microprocessor 300 and its components are generally implemented as electronic circuitry and processor-based computational components controlled by computer instructions stored in physical data storage components 380, including various types of electronic memory and/or mass-storage devices. It should be noted, at the onset, that computer instructions stored in physical data storage devices 380 and executed within processors or microcontrollers 300 comprise the control components of a wide variety of modern devices, machines, and systems, and are as tangible, physical, and real as any other component of a device, machine, or system. Occasionally, statements are encountered that suggest that computer-instruction-implemented control logic is “merely software” or something abstract and less tangible than physical machine components. Those familiar with modern science and technology understand that this is not the case. Computer instructions executed by processors must be physical entities stored in physical devices. Otherwise, the processors would not be able to access and execute the instructions. The term “software” can be applied to a symbolic representation of a program or routine, such as a printout or displayed list of programming-language statements, but such symbolic representations of computer programs are not executed by processors. Instead, processors fetch and execute computer instructions stored in physical states within physical data storage devices 380. Similarly, computer-readable media are physical data storage media 380, such as disks, memories, and mass-storage devices that store data 390 in a tangible, physical form that can be subsequently retrieved from the physical data storage media 380. Moreover, the physical data storage media 380 may optionally be integral with the microprocessor 300.

The microprocessor 300 accesses and uses a variety of different types of stored or received rules, rulesets, information, signals, feedback, data, metrics, measurements or inputs 390, including, user/operator input, in order to generate output controls or commands that may trigger or change processes (such as processes 100, 200) of the microprocessor 300, or otherwise transmit, change, alter or update signals and data. Such changed processes may include, and are not limited to: rules or ruleset changes (whether via generating, ranking, or others), user interface or display changes, updating transaction or sales data, amongst others. The computations may be distributed between the microprocessors 300 and other computing units and/or remotely. Received/measured/analyzed rules, rulesets, variables, data, measurements or metrics 390, or input/stored rules, rulesets, variables, metrics, information or data 390, whether received to the microprocessor 300 by user-input or feedback from processes 100 and/or 200, includes at least the historical quotation/sales data, plurality of solutions, ranked solutions or plurality of solutions, subset probabilities, generated rulesets, ranked rulesets, generated learned rules, explicit rules, new configurations, and assembly item data. Additional information used by the microprocessor 300 in its algorithms may include one or more stored control schedules, algorithms, immediate control inputs received through a control or display interface, and data, commands, commissioning, and other information received from other processing systems (including the data communication between other computing units), remote data-processing systems, including cloud-based data-processing systems (not illustrated) and may further include statistical analysis of mean, deviation, deviation of baseline, Bayesian, and FFT (including other analyses) of data 390. Further, in alternative exemplary embodiments, the microprocessor 300 may monitor and coordinate data feedback and/or input or to alert an operator or user of potential new rankings, frequencies, new probabilities of the data, or new items, itemsets or rules/rulesets. The microprocessor 300, through configuration processes 100, 200 can extract, analyze and deduce from the raw real-time data 390 information or predictions regarding (and not limited to): historical quotation/sales data, the plurality of solutions, ranked solutions or plurality of solutions, subset probabilities, generated rulesets, ranked rulesets, generated learned rules, explicit rules, new configurations, and assembly item data. In addition to generating control output to manipulate the component steps and data 390 of configuration processes 100 and 200, the microprocessor 300 may optionally also provide a LED, graphic, display or analog user interface (including a digital or analog interface or alarm system) that allows users/operators to easily input controls and may also provide or transmit output, data, signals and other information to remote entities, other microcontrollers, and to users through an information-output interface. The interface system may be an actuator mounted electronics having the ability to display information and in-turn communicate further information to a process controller or other instrumentation connected to a network for actuator, including, but not limited to, cloud-based network and storage. Digital communication may allow direct input with the microprocessor unit 300. In this manner, the microprocessor 300 may act as a mechanism to receive feedback to adjust, alter and/or correct the configuration processes 100 and 200 and data 390.

Embodiments of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the disclosed subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium; optical storage medium; magneto-optical storage medium; read only memory; random access memory; erasable programmable memory; flash memory; or other types of medium suitable for storing electronic instructions. In addition, the various embodiments may be embodied in an electrical, optical, acoustical or other form of propagated signal (e.g., carrier waves, infrared signals, digital signals, etc.), or wire line, wireless, or other communications/telemetry medium.

Computer program code for carrying out operations of the embodiments may be written in any combination of one or more programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

The storage device 380 may be any suitable storage device for storing data. The data collection unit 310 may collect, gather, manipulate, and/or categorize the data 390 transmitted by a user or through stored or historical data. The data collection unit 310 may manipulate the collected data into a format that allows the operator, user and/or the microprocessor 300 to take appropriate action during the operations or processing. The risk assessment or analysis unit 320 may receive the categorized data 390 from the data collection unit 310 in order to determine if there is any present or future risks and may make predictions not limited to, inventory availability, cost estimates and/or preventative maintenance service intervals, amongst others. The risk assessment or analysis unit 320 may classify the risks for the microprocessor 300 and/or the operator/user (such as whether to create an alert via notification unit 350). By way of example only, the operator can input a threshold limit or range of the inventory or a user budget, and if the analyzed data or metrics 390 falls outside the desired threshold range(s), can be identified by the microprocessor 300 via the risk assessment analysis unit 320 or other components of the microprocessor 300 (such as the comparative analysis unit 340).

The historical data unit 330 may categorize the historical data, measurements or metrics 390 collected by the data collection unit 310. The comparative analysis unit 340 may compare the data, measurements or metrics 390 collected by the data collection unit 310, the classified risks, and/or the historical data 390 in order to determine a course of action or generate appropriate rules or rulesets for the operator and/or microprocessor 300. The comparative analysis unit 340 may relay information to the notification unit 350 so that the notification unit 350 may alert the operator or user and/or take action. The notification unit 350 may alert the operator or microprocessor 300 of the real time condition, and/or a predicted condition. The notification unit 350 may include visual display interface(s), audible sounds or alarms, a kinetic or automated response, and/or a combination thereof. The transceiver unit 360 and/or the transmitter may be any suitable device configured to send and/or receive data to the microprocessor 300 (such as, by way of example, in certain exemplary embodiments, wires or cables). The implementation unit 370 may be configured create and execute an implementation plan for remediation of the configuration processes 100 and 200. In another example, the operator, user and/or the microprocessor 300 may update, determine or provide predictions as to data 390 as operations or processes 100, 200 are being performed.

While the embodiments are described with reference to various implementations and exploitations, it will be understood that these embodiments are illustrative and that the scope of the inventive subject matter is not limited to them. Many variations, modifications, additions and improvements are possible. The configuration processes 100 and 200 may be provided as a standalone software product or alternatively, as a cloud computing product or service, such as, by way of example, a software-as-a-service (hereinafter, also “SaaS”) product to consumers. Configuration processes 100 and 200 may optionally be referred to as algorithms. Moreover, the figures included within this disclosure depict merely some exemplary embodiments. The performance and features mentioned in this disclosure will be the same.

The disclosure and exemplary embodiments dramatically improve upon existing models for product configuration by applying computational algorithms and methods to the purpose of recommending components for a given quotation process. The process, as disclosed, provides for flexibility in implementation by using a combined learned and explicit ruleset to guide product or product kit or assembly configuration.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method of configurator validation and recommendation comprising the steps of:
collecting historical quotation or sales data;
identifying a plurality of solutions based on the historical quotation or sales data, wherein the plurality of solutions comprises at least one frequent itemset;
ranking the plurality of solutions by frequency;
returning the plurality of solutions in a ranked order;
calculating a subset of probabilities of the at least one frequent itemset;
generating a rule or ruleset based at least on the subset of probabilities;
ranking the rules or ruleset;
storing the generated and ranked rules or ruleset as a generated learned rule or ruleset; and
inserting an explicit rule to the generated learned rules or ruleset.

2. The method according to claim 1, further comprising the steps of:
adding a first assembly item;
querying the generated learned rules or rulesets with the first assembly item;
receiving the plurality of solutions in ranked order relating to the first assembly item; and
displaying the plurality of solutions on a user interface.

3. The method according to claim 2, further comprising the step of adding an additional assembly item and repeating the steps of: querying the generated learned rules or rulesets with the additional assembly item; receiving an additional plurality of solutions in ranked order relating to the additional assembly item; and displaying the additional plurality of solutions on a user interface.

4. The method according to claim 3, wherein the first assembly item is a valve device.

5. The method according to claim 4, wherein the plurality of solutions relate to a plurality of valve accessories which have been previously sold in connection with the valve device in the past, and wherein the additional assembly item is chosen from one of the plurality of valve accessories, and wherein the additional plurality of solutions relate to a second plurality of valve accessories sold in connection with the valve and the additional assembly item.

6. The method according to claim 5, further comprising the step of adding the valve device and the additional assembly item into a product assembly kit.

7. The method according to claim 2, wherein the step of identifying the plurality of solutions based on the historical quotation or sales data comprises generating the at least one frequent itemset in a reduced list of frequent itemsets from the data, wherein the reduced list of frequent itemsets comprises at least one key-value pair, wherein the key is a list of items and the value is the frequency with which a combination of a first item and a second item appears in the data.

8. The method according to claim 7, wherein the step of calculating the subset of probabilities of the at least one frequent itemset comprises calculating a confidence metric, wherein the confidence metric comprises likelihood the second item will occur given the first item in the at least one itemset.

9. The method according to claim 8, wherein the step of calculating the subset of probabilities further comprises calculating a lift metric, wherein the lift metric is high if the second item only ever appears in historical quotation or sales data where the first item is present, and the lift metric is low if the second item appears ubiquitous in all historical quotation or sales data with or without the first item present.

10. The method according to claim 9, wherein the step of inserting an explicit rule is performed when the first item is absent of historical quotation or sales data.

11. The method according to claim 9, wherein the step of inserting an explicit rule comprises substituting an existing rule with the explicit rule.

12. A method of configurator validation and recommendation comprising the steps of:
adding a first assembly item;
querying a generated learned rule or rulesets;
receiving a plurality of solutions in ranked order, wherein the generated learned rule or rulesets reflect historical association data between the plurality of solutions and the first assembly item; and
displaying the plurality of solutions on a user interface.

13. The method according to claim 12, further comprising the step of adding a new rule where the first assembly item has no historical association data.

14. The method according to claim 13, comprising the steps of adding a subsequent assembly item and repeating the following steps until no further subsequent assembly items are desired: querying the generated learned rule or rulesets; receiving the plurality of solutions in ranked order; and displaying the plurality of solutions on the user interface.

15. The method according to claim 14, wherein the plurality of solutions in ranked order further comprises a list of itemsets ranked by frequency of the occurrence of the itemset.

16. An apparatus for a configurator validation and recommendation engine for a valve product assembly kit, comprising:
a microprocessor unit, wherein the microprocessor comprises:
a data collection unit configured to receive data regarding combinations of valve items for the valve product assembly kit;
a data storage unit configured to store data regarding combinations of valve items for the valve product assembly kit;
a comparative analysis unit to compare data, determine or predict via analysis and responsive to the data collection unit and data storage unit and configured to generate a recommended combination of valve items for the valve product assembly kit; and
a notification unit to display the recommended combination of valve items for the valve product assembly kit.

17. The apparatus according to claim 16, further comprising stored rules or rulesets in the data storage unit.

18. The apparatus according to claim 17, wherein the data further comprises historical quotation and sales data.
